(19) United States
(12) Patent Application Publication
(10) Pub. No.: US 2014/0278648 A1
(43) Pub. Date: Sep. 18, 2014

(54) Digital Task List Management and Verification System

(71) Applicant: Robert Benjamin Bussey, Charleston, SC (US)

(72) Inventor: Robert Benjamin Bussey, Charleston, SC (US)

(21) Appl. No.: 14/213,040

(22) Filed: Mar. 14, 2014

Related U.S. Application Data
(60) Provisional application No. 61/794,866, filed on Mar. 15, 2013.

(51) Int. Cl. G06Q 10/06

(52) U.S. Cl. CPC G06Q 10/063114
USPC 705/7.15

(57) ABSTRACT

Remote digital task list management system that allows an admin or manager to customize a task list to be completed and allows the user to verify proper completion of each task and transmit digital proof from a network enabled communication device to the admin or manager, as specified by the admin or manager, in the form of a time stamp, GPS location, photograph, video, written description, and/or audio recording.

### TECHNICAL FIELD

The present invention relates to a digital task list management and verification system adaptable to all varieties of work, errands, chores, and recreational activities.

### BACKGROUND OF THE INVENTION

For thousands of years, people have used task lists, sometimes called checklists, to manage work, errands, and chores. Task lists can be primitively simple. A list of a few tasks written down on a napkin can serve as an effective task list. Some task lists have the additional feature of indicating completion of a task by placing a checkmark next to the task or crossing the task off the list.

The advent of the computer age has led people to prepare and use digital task lists. To date, computers have undoubtedly allowed people to increase the information and complexity of task lists, but the basic operation and function of such task lists has not changed.

Currently, the value and reliability of a task list as a management tool or as proof of completion of the tasks on the list is limited by the veracity, subjectivity, and potential error of the individual performing the tasks on the list.

### BRIEF SUMMARY OF THE INVENTION

The present invention is a remote digital task list management system that allows the admin or manager to customize a task list of tasks to be completed and then allows the user to verify proper completion of each task on the list and send digital proof of completion from a network enabled communication device to the admin or manager, as specified by the admin or manager, in the form of a time stamp, GPS location, photograph, video, and/or audio recording, resulting in unprecedented value and reliability of a task list as a management tool or as verifiable proof of proper completion of the tasks on the list.

### BRIEF DESCRIPTION OF THE SEVERAL VIEWS OF THE DRAWING

FIG. 1 is a semi-schematic flow diagram illustrating a method of remote verification of task completion in accordance with the principles of one embodiment of the present invention including a task list creation application and a marketplace for task lists.

FIG. 2 is a block diagram illustrating a task list that has been distributed via a network to a network enabled device.

FIG. 3 is a block diagram illustrating a user indicating completion of a task and that the task is automatically verified via time stamp, date stamp and GPS-location stamp.

FIG. 4 is a block diagram illustrating a user being prompted to verify a task as complete by taking a photograph of the task.

FIG. 5 is a block diagram illustrating a user verifying a completed task by taking a photograph of the task.

FIG. 6 is a block diagram illustrating a user being prompted to verify a task as complete by taking a photograph of themself (the user).

FIG. 7 is a block diagram illustrating a user verifying a completed task by taking a photograph of themself.

FIG. 8 is a block diagram illustrating a user being prompted to verify a task as complete by taking a photograph of themself (the user) while concurrently (or immediately thereafter) taking a photograph of the completed task.

FIG. 9 is a block diagram illustrating verification of a task indicated as complete by taking a photograph of themself (the user) while concurrently (or immediately thereafter) taking a photograph of the completed task.

FIG. 10 is a block diagram illustrating a user being prompted to verify a task as complete by composing a description of or notes about the completed task.

FIG. 11 is a block diagram illustrating a user verifying a completed task by composing a description of or notes about the completed task.

FIG. 12 is a block diagram illustrating a user being prompted to verify a task as complete by completing an audio recording of or about the completed task.

FIG. 13 is a block diagram illustrating a user verifying a task as complete by completing an audio recording of or about the completed task using audio recording features of a network enabled communication device.

FIG. 14 is a block diagram illustrating a user being prompted to verify a task as complete by recording a video of the completed task.

FIG. 15 is a block diagram illustrating a user verifying a completed task by recording a video of the task.

FIG. 16 is a block diagram illustrating a user being prompted to verify a task as complete by recording a video of themself (the user).

FIG. 17 is a block diagram illustrating a user verifying a completed task by recording a video of themself (the user).

FIG. 18 is a block diagram illustrating a user being prompted to verify a task as complete by recording a video of themself (the user) while concurrently (or immediately thereafter) recording a video of the completed task.

FIG. 19 is a block diagram illustrating verification of a task as complete by recording a video of themself (the user) while concurrently (or immediately thereafter) recording a video of the completed task.

FIG. 20 is a block diagram illustrating a task list on a device that has been completed by the user.

FIG. 21 is a block diagram illustrating a message of successful completion of all tasks in a task list and confirmation of submitting the completed tasks to the server and admin.

FIG. 22 is a flowchart illustrating one method of remote verification of task completion in accordance with the principles of the present invention including a task list creation application and a marketplace for task lists.

### DETAILED DESCRIPTION OF THE INVENTION

Turning now to the drawing in which like reference characters indicate corresponding elements throughout the several views, attention is first directed to FIG. 1, which illustrates an admin 1 who creates a task list 2 and/or acquires from a marketplace task list 18 and distributes to a user or users 4 who must remotely verify completion of assigned tasks 6-17 using a network enabled communication device 5. As the user indicates completion of each task; each task is verified by several methods, depending on the capabilities of the network enabled communication device they are using 6-17. A task may be verified by a time stamp 6 and date stamp 7 which is the local time and date at which they completed the task if device has an available internal clock/calendar. A task may be verified by a geo-location stamp 8 which is the GPS coordinates (as indicated by GPS Satellite 9) of where a network enabled communication device was when the task was indicated complete. A task may be verified by the user by taking a photograph of the task 10 that was completed. A task may be verified by taking a photograph of the user 11. A task may be verified by taking a photograph of the user and the task concurrently at the time of task completion 12. A task may be verified by composing a description of or about a task 13 that was completed. A task may be verified by recording audio of or about a task 14 that was completed. A task may be verified by recording a video of the task 15 at the time of completion. A task may be verified by recording a video of the user at the time of task completion 16. A task may be verified by recording a video of the user and the task concurrently at the time of task completion 17.

The completed tasks would then be sent via a network 3 to a server 4 where they would be accessible by an admin or other users as required by the admin.

FIG. 2 is a block diagram illustrating a task list 2 that has been distributed via a network to a network enabled device 5.

FIG. 3 is a block diagram illustrating a user indicating completion of a task 2 and that the task is automatically verified via time stamp, date stamp and GPS-location stamp 19 on a network enabled device 5.

FIG. 4 is a block diagram illustrating a user being prompted to verify a task 20 they indicated as complete by taking a photograph of the task on a network enabled device 5.

FIG. 5 is a block diagram illustrating a user verifying a completed task 21 by taking a photograph of the task 22 on the network enabled device 5.

FIG. 6 is a block diagram illustrating a user being prompted to verify a task they indicated as complete by taking a photograph of themself (the user) 23 on the network enabled device 5.

FIG. 7 is a block diagram illustrating a user verifying a completed task 24 by taking a photograph of themself 25 on the network enabled device 5.

FIG. 8 is a block diagram illustrating a user being prompted to verify a task they indicated as complete by taking a photograph of themself (the user) while concurrently (or immediately thereafter) taking a photograph of the completed task 26 on a network enabled device 5.

FIG. 9 is a block diagram illustrating verification of a task indicated as complete by taking a photograph of themself (the user) 27 while concurrently (or immediately thereafter) taking a photograph of the completed task 28 on a network enabled device 5.

FIG. 10 is a block diagram illustrating a user being prompted to verify a task as complete by composing a description of or notes about the completed task 29 on a network enabled device 5.

FIG. 11 is a block diagram illustrating a user verifying a completed task by composing a description of or notes about the completed task 30 on a network enabled device 5.

FIG. 12 is a block diagram illustrating a user being prompted to verify a task as complete by completing an audio recording 31 of or about the completed task on a network enabled device 5.

FIG. 13 is a block diagram illustrating a user verifying a task as complete by completing an audio recording of or about the completed task using audio recording features 32 on a network enabled device 5.

FIG. 14 is a block diagram illustrating a user being prompted to verify a task as complete by recording a video 33 of the completed task on a network enabled device 5.

FIG. 15 is a block diagram illustrating a user verifying a completed task by recording a video 34 of the completed task 35 on a network enabled device 5.

FIG. 16 is a block diagram illustrating a user being prompted to verify a task as complete by recording a video of themself 36 (the user) on a network enabled device 5.

FIG. 17 is a block diagram illustrating a user verifying a completed task by recording a video 38 of themself 37 on a network enabled device 5.

FIG. 18 is a block diagram illustrating a user being prompted to verify a task as complete by recording a video of themselves 38 (the user) while concurrently (or immediately thereafter) recording a video of the completed task on a network enabled device 5.

FIG. 19 is a block diagram illustrating verification of a task as complete by recording a video of themself (the user) 39 while concurrently (or immediately thereafter) recording a video of the completed task 40 on a network enabled device 5.

FIG. 20 is a block diagram illustrating a task list 41 on a device that has been completed by the user on a network enabled device 5.

FIG. 21 is a block diagram illustrating a message of successful completion of all tasks in a task list and confirmation of submitting the completed tasks to the server and admin 42 on a network enabled device 5.

FIG. 22 is a flowchart illustrating one embodiment of remote verification of task completion in accordance with the principles of the present invention including a task list creation application 43 and a marketplace for task lists 44. An admin creates a task list using a task list creation application 43 and determines how each task should be verified 46 and then assigns it to a user 47 who accesses the task list on a network enabled device 48 and then completes and verifies the tasks 49. Once a user has completed the task list and submits the completed task list 50 the admin is notified and can access the user's task list along with various reporting features 51.

Alternatively, an admin selects a pre-made task list from a marketplace of task lists 44 and then proceeds as described above 46-51.

An admin may also place created task lists into the marketplace for commercial and personal uses 43-44.

This invention is adaptable to countless uses with substantial benefit. For example, embodiments of this invention could be used by: hotels to manage and verify housekeeping of rooms; health professionals to manage and verify daily medical treatments; Alzheimer patients to manage and verify daily medications; firefighters to manage and verify firefighting and safety procedures; restaurants to manage and verify sanitation and food duties; surgeons to manage and verify surgical procedures; policemen to manage and verify procedures in collecting and preserving evidence; construction workers to manage and verify procedures in constructing buildings; manufacturers to manage and verify manufacturing processes; lawyers to manage and verify litigation practices; farmers to manage and verify daily farming responsibilities; auditors to manage and verify audits; publishers to manage and verify delivery of publications; airlines and pilots to manage and verify pre-flight inspections; mechanics to manage and verify auto repairs; corporations to manage and verify compliance with laws and regulations; scientists to manage and verify steps in scientific experiments and processes; customer service centers to manage and verify customer performance of instructions; shippers to manage and verify delivery of packages; producers and sellers of products to manage and verify consumer adherence to instructions on installation, construction, and use of products; defense contractors to manage and verify compliance with government contracts and procedures for dealing with military assets; storefronts to manage and verify opening and closing procedures; utility companies to manage and verify routine inspections; theme parks to manage and verify routine inspections; bankers to manage and verify compliance with protocol and regulations; and grocery stores to manage and verifying fresh inventory of foods. Again, this list represents examples of just a few of countless applications of the invention. Nearly every individual, corporation, and professional can benefit from using an embodiment of this invention in managing and verifying the tasks with which they are charged.

While the foregoing written description of the invention enables one of ordinary skill to make and use what is considered presently to be the best mode thereof, those of ordinary skill will understand and appreciate the existence of variations, combinations, and equivalents of these specific embodiments. The invention should therefore not be limited by the above described embodiments, but shall include all embodiments within the scope and spirit of the invention.

1. A process for remotely managing and verifying tasks comprising the steps of:
a. providing a first network enabled communication device;
b. inputting, on the first network enabled communication device, a list of one or more tasks;
c. selecting, on the first network enabled communication device, one or more dimensions to verify completion of each task among the group comprising:
(i) indicate complete;
(ii) time and date stamp;
(iii) geo-location stamp;
(iv) photograph of task;
(v) photograph of self;
(vi) video of task;
(vii) video of self;
(viii) audio recording; and
(ix) written description of task;
d. communicating the task list and selected verification dimensions from the first network enabled communication device to one or more additional network enabled communication devices;
e. displaying the task list and selected verification dimensions on the additional network enabled communication devices;
f. verifying completion of each task on the list by the selected verification dimensions using the additional network enabled communication devices;
g. communicating the verification data from the additional network enabled communication devices to a server for storage;
h. retrieving the verification data from the server using the first network enabled communication device; and
i. displaying the tasks that have been completed and the verification data for each completed task on the first network enabled communication device.

2. The process of claim 1 where the task list is created by an admin.

3. The process of claim 1 where the task list is acquired by an admin in a marketplace.

4. The process of claim 1 with an additional step of notifying the first network enabled communication device when the task has been completed and the verification data from the additional network enabled communication devices is received by the server.
